(19) United States
(12) Patent Application Publication
(10) Pub. No.: US 2008/0135615 A1
(43) Pub. Date: Jun. 12, 2008

(54) SYSTEMS AND METHODS FOR INCORPORATING AN RFID CIRCUIT INTO A MEMORY DEVICE

(75) Inventor: Douglas Moran, Carlsbad, CA (US)

Correspondence Address: BAKER & MCKENZIE LLP;PATENT DEPARTMENT, 2001 ROSS AVENUE, SUITE 2300, DALLAS, TX, 75201, US

(73) Assignee: NEOLOGY, INC., Poway, CA (US)

(21) Appl. No.: 11/952,855

(22) Filed: Dec. 7, 2007

Related U.S. Application Data
(60) Provisional application No. 60/869,086, filed on Dec. 7, 2006.

(51) Int. Cl. G08B 13/14; H04Q 5/22; G06K 7/00

(52) U.S. Cl. 235/439; 340/572.4; 340/10.1

(57) ABSTRACT

An integrated circuit, comprises an antenna configured to receive Radio Frequency (RF) signal that include data, including permanent data, a non-volatile memory configured to store the permanent data, and a Radio Frequency Identification (RFID) circuit coupled with the non-volatile memory and the antenna, the RFID circuit comprising RFID memory configured to store a unique identifier and other data, the RFID circuit configured to receive the permanent data via the antenna, store the permanent data in the RFID memory, and transfer the permanent data to the non-volatile memory.

### RELATED APPLICATIONS INFORMATION

This application claims the benefit under 35 U.S.C. 119(e) to U.S. Provisional Patent Application Ser. No. 60/869,086, filed Dec. 7, 2006, and entitled “Semiconductor Package and/or VLSI Device With Embedded RFID Tag,” which is incorporated herein by reference in its entirety as if set forth in full.

### BACKGROUND

1. Technical Field

The embodiments described herein are related to Radio Frequency Identification (RFID) applications, and specifically to the incorporation of an RFID circuit in a semiconductor package or in a Very Large Scale Integration (VLSI) design.

2. Related Art

Non-volatile memory is ubiquitous in electronic applications. Such memories are often used to store, e.g., boot code, encryption keys, usage records, etc. In other words, non-volatile memory is used to store permanent data. This data is often programmed into the memory either in the semiconductor manufacturer's facility, using expensive test equipment, or at the device manufacturer's production facility.

Two common types of non-volatile memory devices are Electrically Programmable Read Only Memory (EPROM) and Electrically Erasable and Programmable Read Only Memory (EEPROM). EPROM is a type of computer memory chip that retains its data when its power supply is switched off, i.e., it is non-volatile. An EPROM is an array of floating-gate transistors individually programmed by an electronic device that supplies higher voltages than those normally used in electronic circuits. Once programmed, an EPROM can be erased only by exposing it to strong ultraviolet light. That UV light usually has a wavelength of 235 nm (for optimum erasure time) and belongs to the UVC range of UV light. EPROMs are easily recognizable by the transparent fused quartz window in the top of the package, through which the silicon chip can be seen, and which permits UV light during erasing.

An EEPROM (also called an E²PROM and pronounced e-two-prom), is a non-volatile storage chip used in computers and other devices to store small amounts of volatile data, e.g., calibration tables or device configuration. When larger amounts of more static data are to be stored (such as in USB flash drives) other memory types like flash memory are more economical.

EEPROMs are realized as arrays of floating-gate transistors. There are different types of electrical interfaces to EEPROM devices. Main categories of these interface types are the serial bus and the parallel bus. How the device is operated depends on the electrical interface. The most common serial interface types are SPI, I²C and 1-Wire. These three example interfaces require between 2 and 4 control signals for operation, resulting in a memory device in an 8 pin (or less) package.

A serial EEPROM typically operates in three phases: OP-Code Phase, Address Phase, and Data Phase. The OP-Code is usually the first 8-bits input to the serial input pin of the EEPROM device (or with most I²C devices, is implicit); followed by 8 to 24 bits of addressing depending on the depth of the device, then data to be read or written.

Each EEPROM device typically has its own set of OP-Code instructions to map to different functions. For example, some of the common operations on SPI EEPROM devices are:

Write Enable (WREN);

Write Disable (WRDI);

Read Status Register (RDSR);

Write Status Register (WRSR);

Read Data (READ); and

Write Data (WRITE).

Other operations supported by some EEPROM devices are Program, Sector Erase, and Chip Erase commands.

Parallel EEPROM devices typically have an 8-bit data bus and an address bus wide enough to cover the complete memory. Most devices have chip select and write protect pins. Operation of a parallel EEPROM is simple and fast when compared to serial EEPROM, but these devices are larger due to the higher pin count (up to 32 pins or more) and have been decreasing in popularity in favor of serial EEPROM or Flash.

The difference between EPROM and EEPROM lies in the way that the memory programs and erases. EEPROM can be programmed and erased electrically using field emission (more commonly known in the industry as “Fowler-Nordheim tunneling”). EPROMs can't be erased electrically, and are programmed via hot carrier injection onto the floating gate. Erase is via an ultraviolet light source, although in practice many EPROMs are encapsulated in plastic that is opaque to UV light, and are “one-time programmable”.

These devices can be stand alone devices, e.g., packaged individually for inclusion in a product, or they can be incorporated into another device. For example, it is common for a VLSI component to include an EEPROM macro within the layout of the component.

Regardless of the type of non-volatile memory a common problem exists when a product, such as a set top box, or television is designed to include a non-volatile memory device. The problem revolves around the fact that it is often necessary to program data into the memory that is unique for each end product. In other words, each memory device must be programmed separately, because the data is unique for each memory. It will be understood that for a product line where millions of units are manufactured, i.e., a set to box product line, the cost and time involved in uniquely programming each memory can be substantial.

In order to program a non-volatile memory device, the device must be powered up and operating so that the data can be programmed, or written into the memory. Currently, if the devices are individually packaged, then programming them requires the semiconductor manufacturer to pull the devices out of storage, power them up, program them, and then ship them to the customer. If the memory is integrated into a VLSI component, then the product manufacturer has to power each component, or at least the memory portion, and program each individual component.

Again, the individual programming of a large number of devices can be time consuming and costly. Moreover, it typically requires that the devices be centrally located, or stored for convenient programming.

### SUMMARY

A VLSI component includes a non-volatile memory and a RFID circuit interfaced with the memory. The RFID device can receive data via RF signals, and can be configured such that it can derive power from the RF signals to power both itself and in certain embodiments the memory in order to receive the data and program the memory with the data, without powering on the rest of the circuitry included VLSI component. In this manner, numerous devices can be programmed individually in a fast, efficient, and cost effective manner.

According to one aspect, an integrated circuit comprises an antenna configured to receive Radio Frequency (RF) signal that include data, including permanent data, a non-volatile memory configured to store the permanent data, and a Radio Frequency Identification (RFID) circuit coupled with the non-volatile memory and the antenna. The RFID circuit comprises RFID memory configured to store a unique identifier and other data. The RFID circuit is configured to receive the permanent data via the antenna, store the permanent data in the RFID memory, and transfer the permanent data to the non-volatile memory.

According to another aspect, a non-volatile memory programming system, comprises a RFID interrogator, and an integrated circuit. The integrated circuit can comprise an antenna configured to receive Radio Frequency (RF) signal that include data, including permanent data, a non-volatile memory configured to store the permanent data, and a Radio Frequency Identification (RFID) circuit coupled with the non-volatile memory and the antenna. The RFID circuit comprises RFID memory configured to store a unique identifier and other data. The RFID circuit is configured to receive the permanent data via the antenna, store the permanent data in the RFID memory, and transfer the permanent data to the non-volatile memory.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an exemplary RFID system;

FIG. 2 is a diagram illustrating an example electronic system configured in accordance with one embodiment;

FIG. 3 is a diagram illustrating an example RFID circuit configured in accordance with one embodiment and that can be used in the system of FIG. 2; and

FIG. 4A-4F are diagrams illustrating various example integrated circuits that can include the RFID circuit of FIG. 3.

### DETAILED DESCRIPTION

RFID is an automatic identification method, relying on storing and remotely retrieving data using devices called RFID tags or transponders. An RFID tag is an object that can be applied to or incorporated into a product, animal, or person for the purpose of identification using radio waves. Some tags can be read from several meters away and beyond the line of sight of the reader.

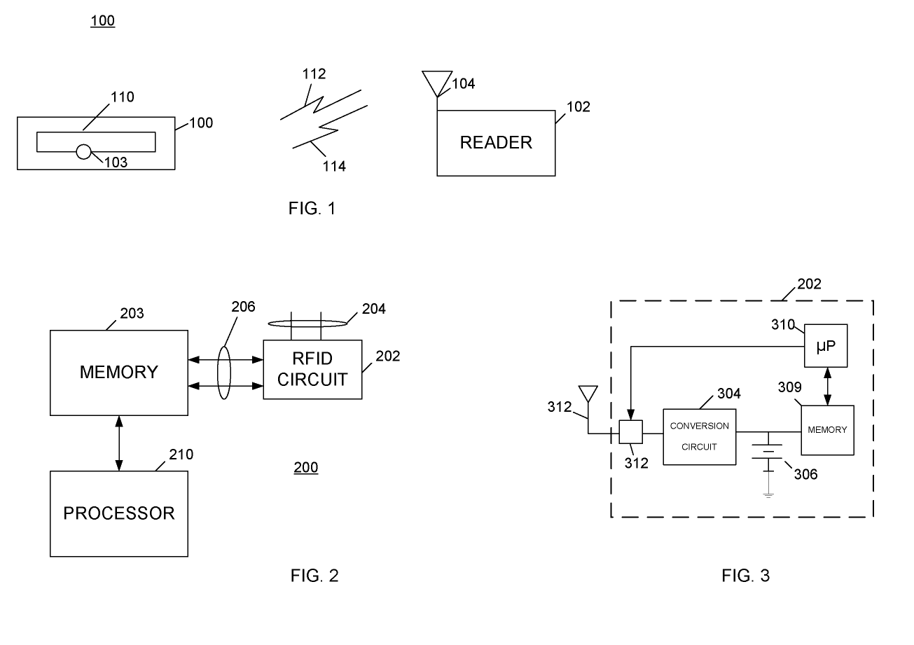

An example RFID system 100 is illustrated in FIG. 1. As can be seen, system 100 comprises a RFID reader 102, which can also be referred to as a scanner or interrogator, and an RFID tag 106. Generally, RFID tag 106 will contain at least two parts. One part is an integrated circuit 108 configured to store and process information, modulate and demodulate RF signals 112, and to perform other custom functions. The second part is an antenna 110 for receiving and transmitting the RF signals 112 from and to the RFID reader 102.

RFID tags 106 come in three general varieties: passive, active, or semi-passive (also known as battery-assisted). Passive tags require no internal power source, thus being pure passive devices (they are only active when a reader is nearby to power them), whereas semi-passive and active tags require a power source, usually a small battery.

To communicate, tag 106 responds to queries from reader 102 by generating signals that must not create interference with reader(s) 102, as signals 112 arriving at tag 106, or other tags within the field of signals 112, can be very weak, but must be received and properly decoded. Often, a technology called backscatter modulation is used by tags 106 to generate the signals that are returned to reader 102. Backscatter is the reflection of waves, particles, or signals back to the direction they came from. Thus, tag 106 can receive RF signals 112, modulate data on to them, and then reflect them back to reader 102 as signals 114.

Besides backscattering, load modulation techniques can be used to manipulate the reader's RF field 112. Typically, backscatter is used in the far field, whereas load modulation applies in the near field, within a few wavelengths from the reader.

Passive RFID tags have no internal power supply. Rather, a minute electrical current is induced in antenna 110 by the incoming RF signals 112 that provides just enough power for, e.g., the CMOS integrated circuit 108, and allows tag 108 to transmit a response 114. Most passive tags signal by backscattering the carrier wave 112 from the reader. This means that antenna 110 has to be designed to both collect power from incoming RF signal 112 and also to transmit the outbound backscatter signal 114.

Passive tags have practical read distances ranging from about 10 cm (4 in.) (ISO 14443) up to a few meters (Electronic Product Code (EPC) and ISO 18000-6), depending on the chosen radio frequency and antenna design/size. Due to their simplicity in design, passive tags are also suitable for manufacture with a printing process for the antennas. The lack of an onboard power supply means that the device can be quite small, which as explained below allows an RFID circuit to be included in a VLSI design, or within an integrated circuit (IC) package containing a non-volatile memory.

Unlike passive RFID tags, active RFID tags have their own internal power source, which is used to power the integrated circuits and broadcast the signal to the reader. Active tags are typically much more reliable (i.e. fewer errors) than passive tags due to the ability for active tags to conduct a “session” with a reader. Active tags, due to their onboard power supply, also transmit at higher power levels than passive tags, allowing them to be more effective in “RF challenged” environments like water (including humans/cattle, which are mostly water), metal (shipping containers, vehicles), or at longer distances, generating strong responses from weak requests (as opposed to passive tags, which work the other way around). In turn, they are generally bigger and more expensive to manufacture, and their potential shelf life is much shorter.

Many active tags today have practical ranges of hundreds of meters, and a battery life of up to 10 years. Active tags typically have much longer range (approximately 500 m/1500 feet) and larger memories than passive tags, as well as the ability to store additional information sent by the transceiver.

Semi-passive tags are similar to active tags in that they have their own power source, but the battery only powers the microchip 108 and does not broadcast a signal. The RF energy 112 is reflected back to reader 102 like a passive tag. An alternative use for the battery is to store energy from reader 102 to emit a response in the future, usually by means of backscattering.

The battery-assisted receive circuitry 108 of semi-passive tag 106 leads to greater sensitivity than passive tags, typically 100 times more. The enhanced sensitivity can be leveraged as increased range (by a factor 10) and/or as enhanced read reliability (by one standard deviation).

The enhanced sensitivity of semi-passive tags place higher demands on reader 102, because an already weak signal is backscattered to the reader. For passive tags, the reader-to-tag link 112 usually fails first. For semi-passive tags, the reverse (tag-to-reader) link 114 usually fails first.

Semi-passive tags have three main advantages 1) Greater sensitivity than passive tags 2) Better battery life than active tags. 3) Can perform active functions under its own power, even when no reader is present.

The antenna 110 used for an RFID tag 106 is affected by the intended application and the frequency of operation. Low-frequency (LF) passive tags are normally inductively coupled, and because the voltage induced is proportional to frequency, many coil turns are needed to produce enough voltage to operate integrated circuit 108.

At 13.56 MHz (High frequency or HF), a planar spiral with 5-7 turns over a credit-card-sized form factor can be used to provide ranges of tens of centimeters. These coils are less costly to produce than LF coils, since they can be made using lithographic techniques rather than by wire winding, but two metal layers and an insulator layer are needed to allow for the crossover connection from the outermost layer to the inside of the spiral where the integrated circuit and resonance capacitor are located.

Ultra-high frequency (UHF) and microwave passive tags are usually radiatively-coupled to the reader antenna and can employ conventional dipole-like antennas. Only one metal layer is required, reducing cost of manufacturing. Dipole antennas, however, are a poor match to the high and slightly capacitive input impedance of a typical integrated circuit 108. Folded dipoles, or short loops acting as inductive matching structures, can be employed to improve power delivery to the IC. Half-wave dipoles (16 cm at 900 MHz) can be too big for many applications; for example, tags embedded in labels must be less than 100 mm (4 inches) in extent. To reduce the length of the antenna, antennas can be bent or meandered, and capacitive tip-loading or bowtie-like broadband structures can also be used. Compact antennas usually have gain less than that of a dipole—that is, less than 2 dBi—and can be regarded as isotropic in the plane perpendicular to their axis.

Dipoles couple to radiation polarized along their axes, so the visibility of a tag with a simple dipole-like antenna is orientation-dependent. Tags with two orthogonal or nearly-orthogonal antennas, often known as dual-dipole tags, are much less dependent on orientation and polarization of the reader antenna, but are larger and more expensive than single-dipole tags.

Patch antennas are used to provide service in close proximity to metal surfaces, but a structure with good bandwidth is 3-6 mm thick, and the need to provide a ground layer and ground connection increases cost relative to simpler single-layer structures.

HF and UHF tag antennas can be fabricated from copper or aluminum. Conductive inks have seen some use in tag antennas but have encountered problems with IC adhesion and environmental stability.

FIG. 2 is a diagram illustrating an example electronic system comprising a RFID circuit 202, a non-volatile memory 208, and a processor 210. non-volatile memory 208 can be configured to store permanent data for system 200. In particular, the permanent data can be specific to the particular system 200, thus requiring that non-volatile memory 208 be programmed individually, as opposed to in bulk with a plurality of other systems, or devices 200. It will be understood that the permanent data can be used by some type of processor, or controller, e.g., processor 210, to perform certain operations within system 200.

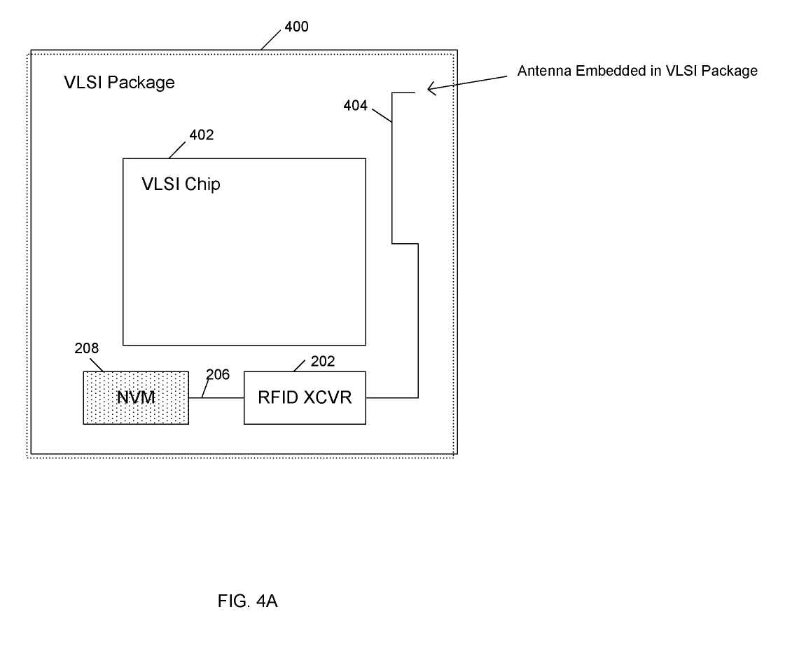

In system 200, however, RFID circuit 202 can be used to program the permanent data into memory 208. For example, RFID circuit 202 can receive the permanent data from a reader 102, store it within RFID memory included in circuit 202 (see FIG. 3), and then transfer the data to non-volatile memory 208, e.g., via communication interface 206.

As described above, communication interface 206 can be a serial interface, such as a 2-wire serial interface or I²C interface. Thus, the RFID controller included in circuit 202 (see FIG. 3) can be configured to store data received from a reader, via antenna port 204 in an RFID memory included in circuit 202, then program the data into memory 208 via communication interface 206 using the appropriate communication protocol and commands, e.g., such as those described above.

This enables fast and efficient remote programming of non-volatile memory 208, because the system 200 does not need to be powered on, i.e., RFID circuit 202 can be a passive circuit that receives power via signals received using port 204. Also, a unique identifier stored in the RFID memory can be used to allow the reader to identify the system, or device 200 and program the data unique to that device as described below.

Depending on the embodiment, RFID circuit 202 can be configured to use the power received via port 204 to power up and program memory 208. In other embodiments, a global system power supply can be used to power memory 208 and RFID circuit 202, after the data has been written to RFID circuit 202, and allow RFID circuit 202 to transfer the data to memory 208.

RFID circuit 202 and memory 208 can be part of a VLSI circuit that, e.g., includes processor 210 and/or other circuits. Alternatively, RFID circuit 202 and memory 208 can be separate circuits that are packaged together. In either case, the antenna interface with RFID circuit 202 can be integrated within the package material.

Thus, a plurality of systems or device 200 can be placed in a tray and brought within range of a reader in order to program unique data into each device 200, without applying power to the devices. Moreover, this can be done at the semiconductor manufacturer's facility or the device manufacturer's facility and does not require expensive machinery or time consuming processes.

As mentioned, a unique identifier programmed into RFID memory can be used to identify a particular device 200 so that the data unique to that device can be programmed into memory 208. If several devices are present, then this requires some ability to isolate a specific device in order to program that device. U.S. Pat. No. 5,856,788 to Ron Walter et al., entitled “Method And Apparatus For Radiofrequency Identification of Tags,” which is incorporated herein by reference in its entirety as if set forth in full, describes one example method for isolating a specific device using a bit-by-bit identification process. U.S. Pat. Nos. 6,690,264 7,064,653, both to Dave Dalglish and both entitled “Selective Cloaking Circuit For Use In Radio Frequency Identification And Method Of Cloaking RFID Tags,” both of which are incorporated herein by reference in its entirety as if set forth in full, described methods for cloaking RFID tags that can also be used to isolate and communicate with specific tags.

Thus, a reader can isolate the RFID circuit 202 within a specific device 200 using a unique identifier and/or other identifying information and then write the associated permanent data to the RFID circuit 202 for transfer to memory 208. U.S. Pat. No. 7,081,819 to Cortina et al., entitled “System and Method For Providing Secure Identification Solutions,” which is incorporated herein by reference in its entirety as if set forth in full, describes methods for using identifying information stored in RFID memory of an RFID circuit to validate the identity of, e.g., a device with which the RFID circuit is associated.

FIG. 3 is a diagram illustrating an example RFID circuit 202 configured in accordance with one embodiment. In the example if FIG. 3, RFID circuit 202 is a passive RFID circuit. In many embodiments this will be preferable since the reduced foot print of a passive circuit can allow the circuit to be included in, e.g., a VLSI design or to be packaged with a memory; however, it will be understood that active or semi-passive circuits can also be used. For example, a global, or system power supply can be used as the power source for an active or semi-passive circuit. This would require, however, that device 200 be powered up in order to program the device, which as noted may not be as preferable.

Referring to FIG. 3, an RFID circuit 202 can include an impedance circuit 302, a power conversion circuit 304, a storage circuit or device 306, a RFID memory 308 and a processor or controller 310.

The impedance circuit 302 can be configured to match the impedance of an antenna 302 so that circuit 202 can receive RF signals via antenna 302. Power conversion circuit 304 can be configured to convert the energy of signals received via antenna 312 into a DC voltage that can be store in storage device 306. Thus, conversion circuit 304 can comprise some form of rectifying circuit. Storage device 306 can, e.g., be a large capacitor or other circuit capable of storing the voltage generated by conversion circuit 304. Thus, circuit 304 and storage device 306 can form a power supply circuit for circuit 202.

RFID memory 308 can be configured to store data, such as a unique identifier as well as data included in signals received via antenna 312. Processor 310 can be configured to control the operation of circuit 202. For example, processor 310 can be configured to decode information included on signals received via antenna 312. This data can include commands, e.g., requesting processor 310 to store data in memory 308 or read data out of memory 308. Processor 310 can be configured to control impedance circuit 302 in order to transmit data read out of memory 308 back to a reader. For example, processor 310 can be configured to alternately short antenna 312 so as to modulate and reflect an incoming RF signal with data.

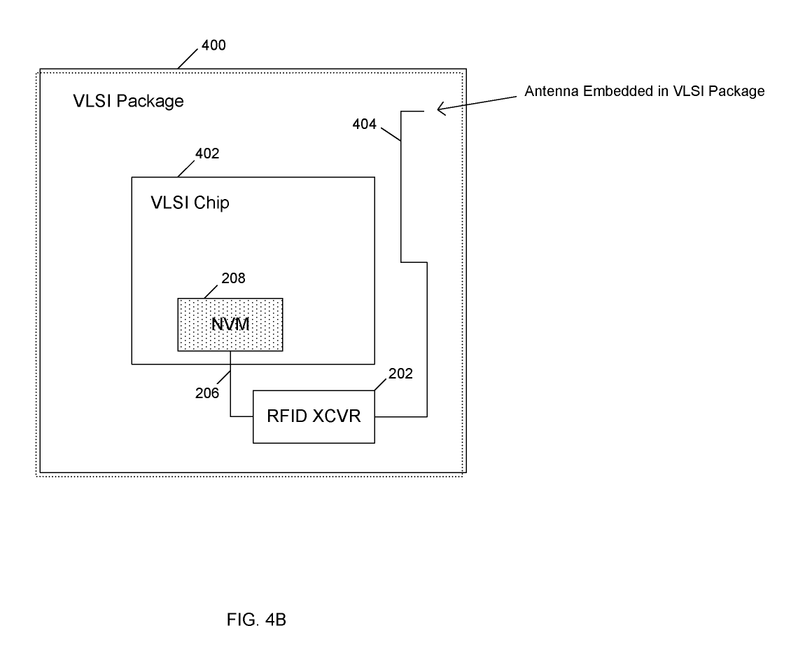

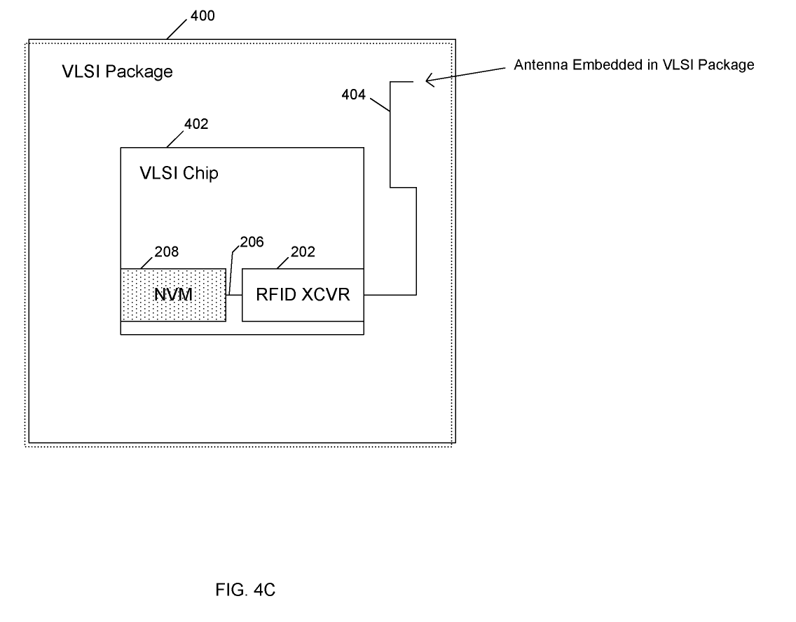

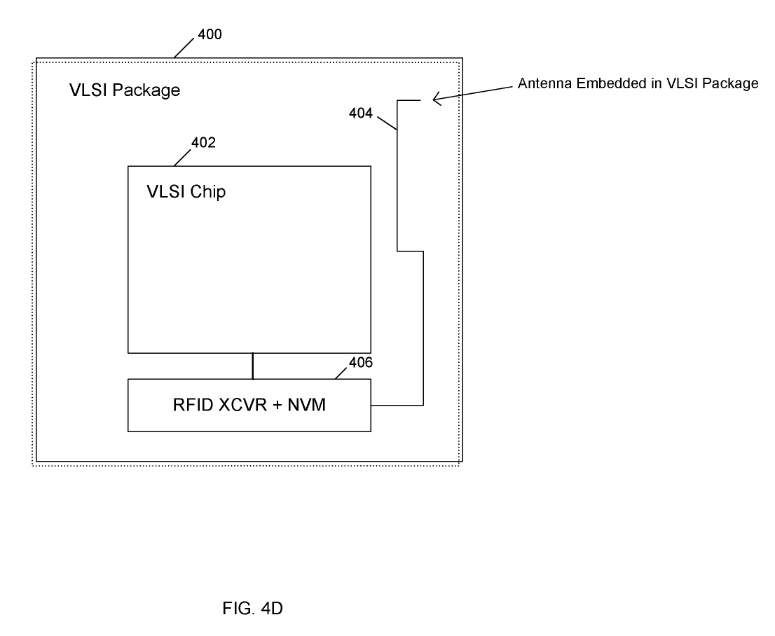

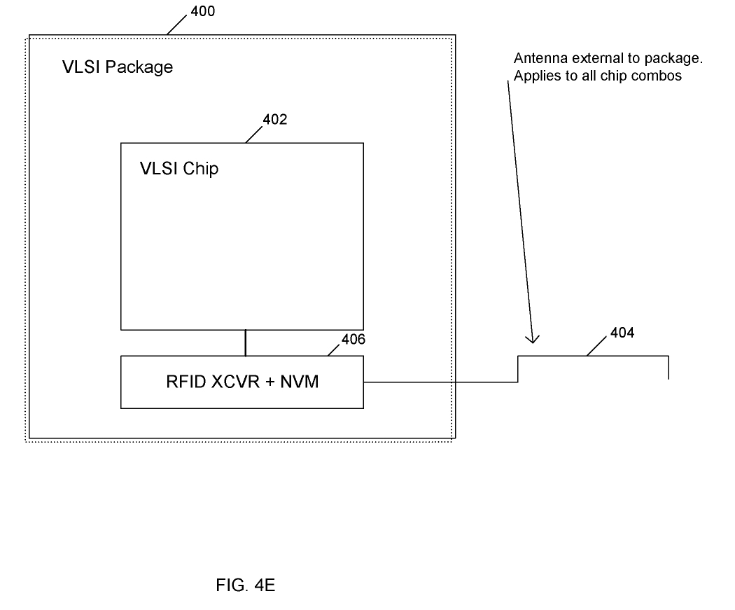

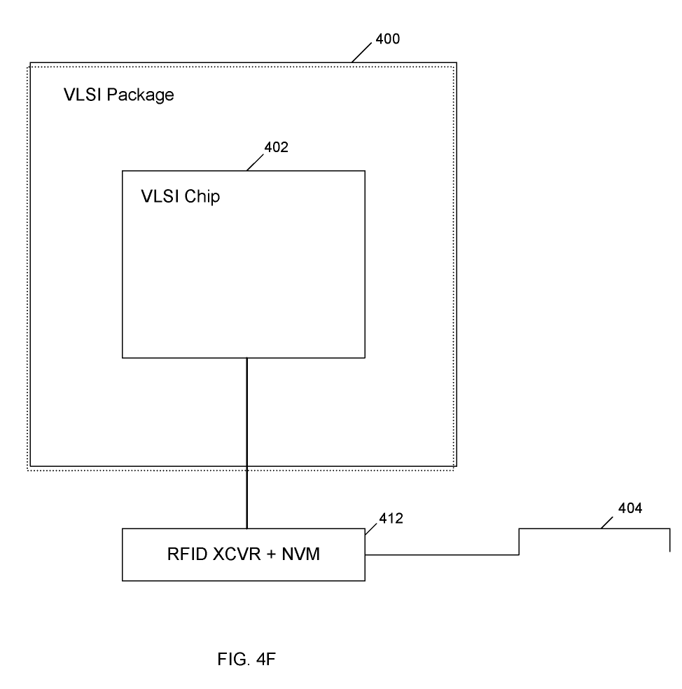

FIGS. 4A-4F illustrated various example integrated circuit configurations that include both a non-volatile memory 208 and a RFID circuit 202. For example, in FIG. 4A, integrated circuit includes both non-volatile memory 208 and a RFID circuit 202 with a separate VLSI circuit within a common package. As mentioned above, antenna 404 can be integrated within the package material.

In FIG. 4B, the non-volatile memory can actually be included in the VLSI circuit 402, while in FIG. 4C both the non-volatile memory 208 and a RFID circuit 202 can be included in VLSI circuit 402.

In FIG. 4D, the non-volatile memory 208 and a RFID circuit 202 can be included in a separate circuit 406 that is still packaged with VLSI circuit 402.

It should be noted that as illustrated in FIG. 4E, antenna 4040 can also be external to the package of integrated circuit 400.

In FIG. 4F, the non-volatile memory 208 and a RFID circuit 202 can be included in a separate integrated circuit 412. In such embodiments, antenna 404 can be external, as illustrated, or integrated into the packaging of integrated circuit 412.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. An integrated circuit, comprising:
an antenna configured to receive Radio Frequency (RF) signal that include data, including permanent data;
a non-volatile memory configured to store the permanent data; and
a Radio Frequency Identification (RFID) circuit coupled with the non-volatile memory and the antenna, the RFID circuit comprising RFID memory configured to store a unique identifier and other data, the RFID circuit configured to receive the permanent data via the antenna, store the permanent data in the RFID memory, and transfer the permanent data to the non-volatile memory.

2. The integrated circuit of claim 1, wherein the RFID circuit further comprises a storage circuit configured to store energy included in the RF signals, and a power supply circuit coupled with the storage circuit, the power supply circuit configured to use the stored energy to supply power to the RFID circuit and the non-volatile memory.

3. The integrated circuit of claim 1, further comprising a global power supply circuit coupled with the non-volatile memory and the RFID circuit, and wherein the global power supply circuit is configured to power the non-volatile memory and the RFID circuit in order to allow the RFID circuit to transfer the permanent data to the non-volatile memory.

4. The integrated circuit of claim 1, further comprising a communication interface coupling the non-volatile memory with the RFID circuit, and wherein the RFID circuit uses the non-volatile memory to transfer the permanent data to the non-volatile memory.

5. The integrated circuit of claim 4, wherein the communication interface is a serial interface.

6. The integrated circuit of claim 1, wherein the RFID memory is configured to store a unique identifier.

7. The integrated circuit of claim 6, wherein the RFID circuit is configured to use the unique identifier to only store data that is intended for the integrated circuit.

8. The integrated circuit of claim 1, further comprising a package, and wherein the antenna is integrated with the package.

9. The integrated circuit of claim 1, wherein the integrated circuit is a Very Large Scale Integrated (VLSI) circuit, and wherein the non-volatile memory and the RFID circuit are part of the VLSI circuit.

10. A non-volatile memory programming system, comprising:
a RFID interrogator; and
an integrated circuit, comprising:
an antenna configured to receive Radio Frequency (RF) signal that include data, including permanent data,
a non-volatile memory configured to store the permanent data, and
a Radio Frequency Identification (RFID) circuit coupled with the non-volatile memory and the antenna, the RFID circuit comprising RFID memory configured to store a unique identifier and other data, the RFID circuit configured to receive the permanent data via the antenna, store the permanent data in the RFID memory, and transfer the permanent data to the non-volatile memory.

11. The non-volatile memory programming system of claim 10, wherein the RFID reader is configured to write permanent data to be stored in the non-volatile memory to the RFID circuit.

12. The non-volatile memory programming system of claim 11, wherein the RFID memory is configured to store a unique identifier, and wherein the RFID reader is configured to read the unique identifier, verify the identity of the integrated circuit based on the unique identifier, and then write the permanent data to the RFID circuit when the unique identifier is verified.

13. The non-volatile memory programming system of claim 12, wherein the RFID reader is configured to isolate the integrated circuit form among a plurality of integrated circuits using the unique identifier, before writing the permanent data to the RFID circuit.

14. The non-volatile memory programming system of claim 10, wherein the RFID circuit further comprises a storage circuit configured to store energy included in the RF signals, and a power supply circuit coupled with the storage circuit, the power supply circuit configured to use the stored energy to supply power to the RFID circuit.

15. The non-volatile memory programming system of claim 14, wherein the storage circuit comprises a rectifier configured to rectify a signal received from the antenna and a large capacitor, and wherein the rectified signal charges the capacitor.

16. The non-volatile memory programming system of claim 14, wherein the RFID circuit is further configured to supply power to the non-volatile memory using the stored energy in the power supply circuit.

17. The non-volatile memory programming system of claim 10, further comprising a global power supply circuit coupled with the non-volatile memory and the RFID circuit, and wherein the global power supply circuit is configured to power the non-volatile memory and the RFID circuit in order to allow the RFID circuit to transfer the permanent data to the non-volatile memory.

18. The non-volatile memory programming system of claim 10, further comprising a communication interface coupling the non-volatile memory with the RFID circuit, and wherein the RFID circuit uses the non-volatile memory to transfer the permanent data to the non-volatile memory.

19. The non-volatile memory programming system of claim 18, wherein the communication interface is a serial interface.

20. The non-volatile memory programming system of claim 10, further comprising a package, and wherein the antenna is integrated with the package.

21. The non-volatile memory programming system of claim 10, wherein the integrated circuit is a Very Large Scale Integrated (VLSI) circuit, and wherein the non-volatile memory and the RFID circuit are part of the VLSI circuit.
